(19) United States
(12) Patent Application Publication
(10) Pub. No.: US 2023/0380624 A1
(43) Pub. Date: Nov. 30, 2023

(54) Grilling Sheet Assembly

(71) Applicant: Keith Nepp, Jurupa Valley, CA (US)

(72) Inventor: Keith Nepp, Jurupa Valley, CA (US)

(21) Appl. No.: 17/827,867

(22) Filed: May 30, 2022

(51) Int. Cl. A47J 36/02; A47J 37/07

(52) U.S. Cl. CPC A47J 36/022; A47J 37/0786

(57) ABSTRACT

A grilling sheet assembly for cooking a food item on a cooking grill includes a sheet that is comprised of a thermally conductive material thereby facilitating the sheet to be heated by a cooking grill when the sheet is positioned on the cooking grill. The sheet is comprised of a rigid material thereby facilitating the sheet to support a food item. Additionally, the sheet is corrugated thereby facilitating the sheet to drain grease from the food item to drip below the food item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to grilling devices and more particularly pertains to a new grilling device for cooking a food item on a cooking grill. The device includes a sheet that has dimensions sufficient to place the sheet on a cooking grill. The sheet is comprised of a thermally conductive material to facilitate the sheet to be heated by the cooking grill. Additionally, the sheet is corrugated to facilitate grease from the food item to drain away from the food item while the food item is being cooked.

### (2) Description of Related Art Including Information Disclosed Under 37 CFR 1.97 and 1.98

The prior art relates to grilling devices including a rolled sheet that is formed with saw-tooth corrugation. The prior art discloses a disposable broiling tray that is formed with saw-tooth corrugation. The prior art discloses a cooking foil sheet that is comprised of a foil upper layer, a dry bibulous center layer and an imperforate lower layer. The prior art discloses a flexible foil that is rolled into a sheet which can be torn into a desired length and formed into a pan for cooking. The prior art discloses a cooking sheet that is corrugated and which has an upper chamber and a lower chamber defined in each of the corrugations. The prior art disclose a cooking liner that is corrugated and which has a perforated section and a non-perforated section.

### BRIEF SUMMARY OF THE INVENTION

An embodiment of the disclosure meets the needs presented above by generally comprising a sheet that is comprised of a thermally conductive material thereby facilitating the sheet to be heated by a cooking grill when the sheet is positioned on the cooking grill. The sheet is comprised of a rigid material thereby facilitating the sheet to support a food item. Additionally, the sheet is corrugated thereby facilitating the sheet to drain grease from the food item to drip below the food item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a grilling sheet assembly according to an embodiment of the disclosure.

FIG. 2 is a front view of an embodiment of the disclosure.

FIG. 3 is a top view of an embodiment of the disclosure.

FIG. 4 is a perspective in-use view of an embodiment of the disclosure.

### DETAILED DESCRIPTION OF THE INVENTION

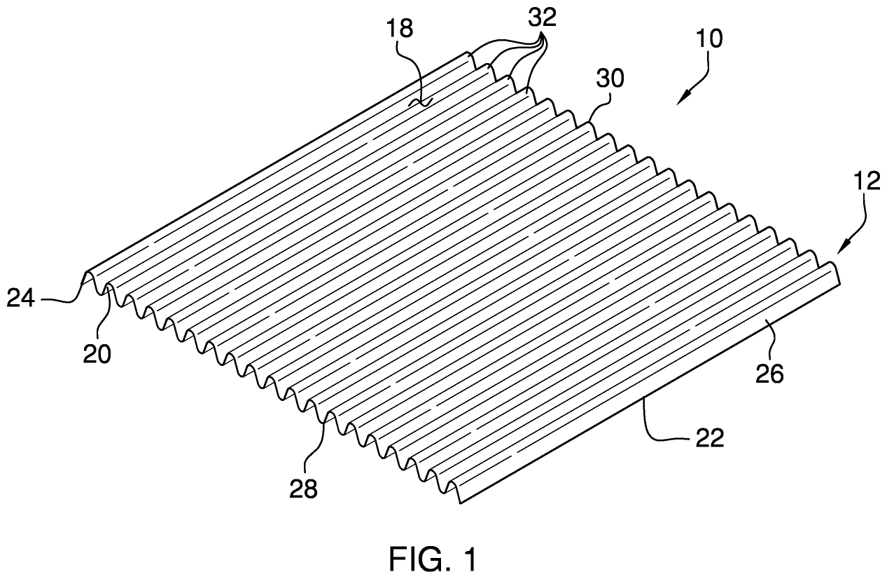

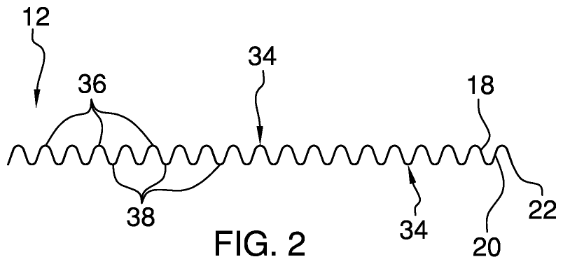

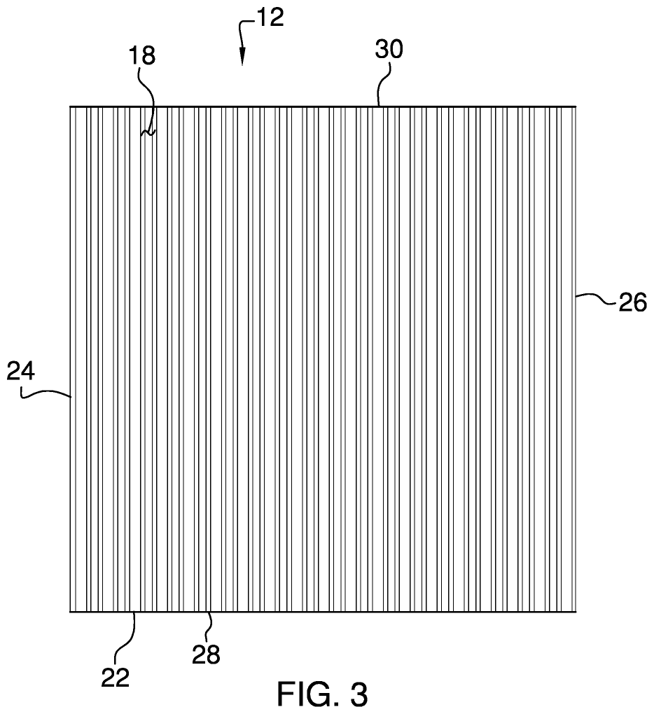

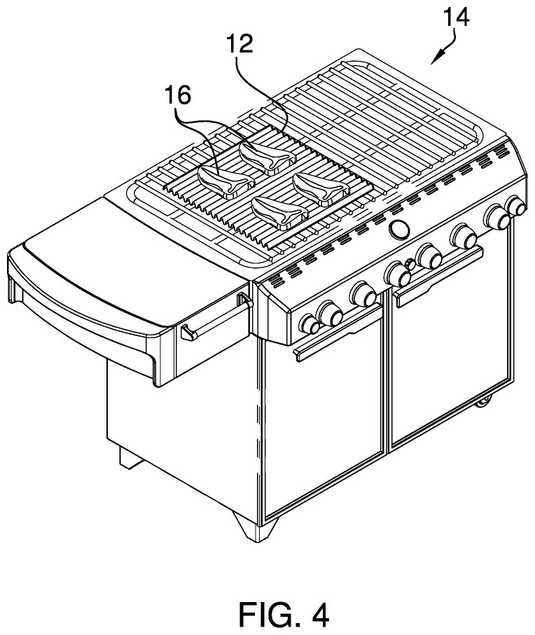

With reference now to the drawings, and in particular to FIGS. 1 through 4 thereof, a new grilling device embodying the principles and concepts of an embodiment of the disclosure and generally designated by the reference numeral 10 will be described.

As best illustrated in FIGS. 1 through 4, the grilling sheet assembly 10 generally comprises a sheet 12 that is comprised of a thermally conductive material thereby facilitating the sheet 12 to be heated by a cooking grill 14 when the sheet 12 is positioned on the cooking grill 14. The cooking grill 14 may be a charcoal grill, a gas grill or any other type of cooking grill that burns a combustible fuel to cook a food item 16. The sheet 12 is comprised of a rigid material, such as aluminum, thereby facilitating the sheet 12 to support a food item 16. Furthermore, the sheet 12 is corrugated thereby facilitating the sheet 12 to drain grease from the food item 16 to drip below the food item 16.

The sheet 12 has a top surface 18, a bottom surface 20 and a perimeter edge 22 extending between the top surface 18 and the bottom surface 20, and the perimeter edge 22 has a first lateral side 24, a second lateral side 26, a front side 28 and a back side 30. The sheet 12 has plurality of bends 32 each extending between the front side 28 and the back side 30 and the plurality of bends 32 are distributed between the first lateral side 24 and the second lateral side 26. Additionally, an apex 34 of each of the bends 32 may be curved or flattened.

The plurality of bends 32 includes a set of first bends 36 and a set of second bends 38. Each of the first bends 36 is directed upwardly and each of the second bends 38 is directed downwardly. Furthermore, the first bends 36 and the second bends 38 alternate between the first lateral side 24 and the second lateral side 26. Each of the first lateral side 24, the second lateral side 26, the front side 28 and the back side 30 has a length that is less than 18.0 inches thereby facilitating the sheet 12 to fit on a typical cooking grill 14. Additionally, the sheet 12 has a thickness between the top surface 18 and the bottom surface 20 that is less than 0.08 mm thereby facilitating the sheet 12 to be crumpled into a ball to be discarded when the food item 16 has finished cooking. The rigid material of which the sheet 12 is constructed may be aluminum foil to facilitate the sheet 12 to be crumpled by a person of average strength. Furthermore, the sheet 12 may be packaged with a plurality of the sheets 12 in a box that can be purchased in a retail environment.

In use, the sheet 12 is placed on the cooking grill 14 such that the sheet 12 is heated when the cooking grill 14 is turned on. In this way the sheet 12 facilitates a clean surface upon which the food item 16 can be cooked in the cooking grill 14. The food item 16 is placed on the sheet 12 to facilitate the food item 16 to be cooked. Additionally, the corrugation of the sheet 12 facilitates grease to drain away from the food item 16 as the food item 16 is being cooked. The food item 16 is removed from the sheet 12 and the sheet 12 is crumpled into a ball and discarded when the food item 16 is cooked.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A grilling sheet assembly being positionable on a cooking grill thereby facilitating a food item to be cooked on a clean surface, said assembly comprising:
a sheet being comprised of a thermally conductive material thereby facilitating said sheet to be heated by a cooking grill when said sheet is positioned on the cooking grill, said sheet being comprised of a rigid material thereby facilitating said sheet to support a food item, said sheet being corrugated thereby facilitating said sheet to drain grease from the food item to drip below the food item.

2. The assembly according to claim 1, wherein:
said sheet has a top surface, a bottom surface and a perimeter edge extending between said top surface and said bottom surface, said perimeter edge having a first lateral side, a second lateral side, a front side and a back side;
said sheet has plurality of bends each extending between said front side and said back side, said plurality of bends being distributed between said first lateral side and said second lateral side;
said plurality of bends includes a set of first bends and a set of second bends;
each of said first bends is directed upwardly;
each of said second bends is directed downwardly; and
said first bends and said second bends alternate between said first lateral side and said second lateral side.

3. The assembly according to claim 2, wherein each of said first lateral side and said second lateral side and said front side and said back side has a length being less than 18.0 inches thereby facilitating said sheet to fit on a typical cooking grill.

4. The assembly according to claim 2, wherein said sheet has a thickness between said top surface and said bottom surface being less than 0.08 mm thereby facilitating said sheet to be crumpled into a ball to be discarded when the food item has finished cooking.

5. A grilling sheet assembly being positionable on a cooking grill thereby facilitating a food item to be cooked on a clean surface, said assembly comprising:
a sheet being comprised of a thermally conductive material thereby facilitating said sheet to be heated by a cooking grill when said sheet is positioned on the cooking grill, said sheet being comprised of a rigid material thereby facilitating said sheet to support a food item, said sheet being corrugated thereby facilitating said sheet to drain grease from the food item to drip below the food item, said sheet having a top surface, a bottom surface and a perimeter edge extending between said top surface and said bottom surface, said perimeter edge having a first lateral side, a second lateral side, a front side and a back side, said sheet having plurality of bends each extending between said front side and said back side, said plurality of bends being distributed between said first lateral side and said second lateral side, said plurality of bends including a set of first bends and a set of second bends, each of said first bends being directed upwardly, each of said second bends being directed downwardly, said first bends and said second bends alternating between said first lateral side and said second lateral side, each of said first lateral side and said second lateral side and said front side and said back side having a length being less than 18.0 inches thereby facilitating said sheet to fit on a typical cooking grill, said sheet having a thickness between said top surface and said bottom surface being less than 0.08 mm thereby facilitating said sheet to be crumpled into a ball to be discarded when the food item has finished cooking.

6. A grilling sheet system being positionable on a cooking grill thereby facilitating a food item to be cooked on a clean surface, said system comprising:
a cooking grill for burning a combustible fuel to cook a food item;
a sheet being comprised of a thermally conductive material thereby facilitating said sheet to be heated by said cooking grill when said sheet is positioned on said cooking grill, said sheet being comprised of a rigid material thereby facilitating said sheet to support the food item, said sheet being corrugated thereby facilitating said sheet to drain grease from the food item to drip below the food item, said sheet having a top surface, a bottom surface and a perimeter edge extending between said top surface and said bottom surface, said perimeter edge having a first lateral side, a second lateral side, a front side and a back side, said sheet having plurality of bends each extending between said front side and said back side, said plurality of bends being distributed between said first lateral side and said second lateral side, said plurality of bends including a set of first bends and a set of second bends, each of said first bends being directed upwardly, each of said second bends being directed downwardly, said first bends and said second bends alternating between said first lateral side and said second lateral side, each of said first lateral side and said second lateral side and said third lateral side and said fourth lateral side having a length being less than 18.0 inches thereby facilitating said sheet to fit on a typical cooking grill, said sheet having a thickness between said top surface and said bottom surface being less than 0.08 mm thereby facilitating said sheet to be crumpled into a ball to be discarded when the food item has finished cooking.
